(19) United States
(12) Patent Application Publication
(10) Pub. No.: US 2013/0192328 A1
(43) Pub. Date: Aug. 1, 2013

(54) EXTRUSION METHOD

(71) Applicant: Kimihisa Hiramoto, Oyama-shi (JP)

(72) Inventor: Kimihisa Hiramoto, Oyama-shi (JP)

(73) Assignee: SHOWA DENKO K.K., Minato-ku, Tokyo (JP)

(21) Appl. No.: 13/575,319

(22) PCT Filed: Jan. 25, 2011
(86) PCT No.: PCT/JP2011/051260

§ 371 Date: Sep. 17, 2012

(30) Foreign Application Priority Data
Jan. 27, 2010 (JP) 2010-015021

(51) Int. Cl. B05D 5/00; B21C 23/00

(52) U.S. Cl. CPC B05D 5/00; B21C 23/00
USPC 72/273; 427/372.2

(57) ABSTRACT

An extrusion method capable of performing extrusion by means of an extrusion die that can improve oxidation resistance while maintaining the excellent performance of titanium sintered body is provided. The present invention is directed to an extrusion method in which an extrusion material F is extruded through an extrusion hole 33 of a main die body 31. A main die body 31 is prepared, wherein the main die body 31 is constituted by surface-coated cermet material 1 containing cermet base material 11 formed of a sintered body including at least one or more titanium compounds selected from the group consisting of titanium carbide, titanium nitride, and titanium carbonitride as a main component, and an oxidation resistant film 12 formed on a section on the cermet base material 11 corresponding to at least an inner peripheral surface of the extrusion hole and formed of a complex oxide containing titanium. The extrusion die is preheated to a temperature of 420 to 520° C. before initiating the extrusion.

### TECHNICAL FIELD

The present invention relates to an extrusion method using an extrusion die constituted by a titanium series sintered body, and also relates to its related technologies.

### BACKGROUND TECHNIQUE

A titanium carbonitride series sintered body (titanium carbonitride base cermet) having titanium carbonitride (TiCN) as a main component of a hard phase and iron group metal as a main component of a bonded phase has excellent characteristics, such as, e.g., being high in hardness and strength, as well as being hard to react with aluminum and its alloy, high in slide characteristic with respect to various metals, and capable of obtaining a low coefficient of friction. For such reasons, a titanium carbonitride series sintered body is suitably used for a metal processing product, such as, e.g., a tube diameter expansion die, a tube diameter reduction die, or a cutting chip for a metal pipe.

However, when such TiCN series cermet is exposed to an atmosphere containing oxygen at a high temperature, titanium which is a structural element thereof is oxidized to create titanium oxide on the cermet surface. Since the titanium oxide is brittle, when metal is processed with a cermet tool having a titanium oxide film, the titanium oxide film falls off, causing a rough surface, which in turn deteriorates the machining performance. Furthermore, the titanium oxide layer is abraded quickly, which deteriorates the durability.

Under the circumstances, in order to improve the oxidation resistance of titanium series cermet, it has been proposed to add other elements to the component constituting the cermet.

For example, in the case of the cermet disclosed by Patent Document 1, chromium is added to the titanium series sintered material, so that the cermet is constituted by a complex compound of chromium (Cr) and titanium (Ti) as a main component to improve the oxidation resistance.

On the other hand, although the purpose is not to improve oxidation resistance, conventionally, many surface-coated cermet materials in which a hard film is formed on a titanium series sintered body have been proposed.

For example, in the case of the surface-coated cermet member disclosed by Patent Document 2, a hard film containing titanium is formed on the surface of the cermet as a base material by means of, e.g., a CVD (chemical vapor deposition method) and a PVD (physical vapor deposition method).

Furthermore, in the case of the surface-coated cermet material disclosed by Patent Document 3, a hard film is formed on a surface of a cermet base material and a diffusing element contained layer is formed at the boundary between the surface of the cermet base material and the hard film to improve adhesion of the hard film.

### PRIOR ART

### Patent Document

Patent Document 1: Japanese Unexamined Laid-open Patent Application Publication No. 2006-213977 (see claims)
Patent Document 2: Japanese Unexamined Laid-open Patent Application Publication No. 2005-111623 (see claims)
Patent Document 3: Japanese Unexamined Laid-open Patent Application Publication No. 2000-355777 (see claims)

### SUMMARY OF THE INVENTION

### Problems to be Solved by the Invention

However, in the cermet (sintered body) in which other components are added to components of a titanium series sintered material as disclosed by Patent Document 1, the cermet is different in component from a titanium series sintered body, and changes in quality, which causes a problem that the excellent performance of the titanium series sintered body is deteriorated.

In the surface-coated cermet material disclosed by Patent Document 2, a hard film is simply formed by diffusion. The cermet member, however, differs in the amount of diffusion between the bonded phase (Co) and the hard phase (TiC) of the cermet base material. For this reason, for example, the diffusion hardly progresses on the hard phase, causing a problem that adhesion of the hard film deteriorates, which makes it difficult to maintain sufficient oxidation resistance due to detachment.

In the surface-coated cermet material disclosed by Patent Document 3, a diffusing element contained layer is further formed at the boundary between the hard film and the cermet base material, which causes a problem that the structure becomes complicate, resulting in difficult production.

The preferred embodiments of the present invention have been developed in view of the above-mentioned and/or other problems in the related art. The preferred embodiments of the present invention can significantly improve upon existing methods and/or apparatuses.

The present invention was made in view of the aforementioned problems, and aims to provide an extrusion method and its related technologies using an easy-to-produce extrusion die capable of improving oxidation resistance while keeping the excellent performance of titanium series sintered body.

Other objects and advantages of the present invention will be apparent from the following preferred embodiments.

### Means for Solving the Problems

In order to attain the aforementioned objects, the present invention has the structure summarized below.

[1] An extrusion method of extruding an extrusion material through an extrusion hole of a die main body of an extrusion die,

wherein the die main body is constituted by a surface-coated cermet material including a cermet base material constituted by a sintered body including as a main component of a hard phase at least one or more titanium compounds selected from the group consisting of titanium carbide, titanium nitride, and titanium carbonitride, and an oxidation resistant film provided at a section on the cermet base material corresponding to at least an inner peripheral surface of the extrusion hole and constituted by complex oxide containing titanium, and

wherein the extrusion die is preheated to a temperature of 420 to 520° C. before initiating the extrusion.

[2] The extrusion method as recited in the aforementioned Item 1, wherein a preheating time of the extrusion die is set to 24 hours or less.

[3] The extrusion method as recited in the aforementioned Item 1 or 2, wherein the extrusion is performed such that, after initiating the extrusion, the oxidation resistant film on the inner peripheral surface of the extrusion hole is exfoliated and removed by the extrusion material passing through the shaped hole.

[4] The extrusion method as recited in any one of the aforementioned Items 1 to 3, wherein the titanium compound is constituted by titanium carbonitride.

[5] The extrusion method as recited in any one of the aforementioned Items 1 to 4, wherein the oxidation resistant film is formed by applying a processing solution containing metal salt which reacts with the titanium compound on a surface of the cermet base material to produce the complex oxide onto the cermet base material and then heating the cermet base material on which the processing solution is applied.

[6] The extrusion method as recited in the aforementioned Item 5, wherein the cermet base material is subjected to oxidation treatment before applying the processing solution.

[7] The extrusion method as recited in any one of the aforementioned Items 1 to 6, wherein the oxidation resistant film is constituted by perovskite-type complex oxide.

[8] The extrusion method as recited in the aforementioned Item 7, wherein the oxidation resistant film is formed by applying a processing solution containing alkaline earth metal compound onto the cermet base material and then heating the cermet base material on which the processing solution is applied.

[9] The extrusion method as recited in any one of the aforementioned Items 1 to 6, wherein the oxidation resistant film is constituted by ilmenite-type complex oxide.

[10] The extrusion method as recited in the aforementioned Item 9, wherein the oxidation resistant film is formed by applying a processing solution containing iron group divalent ion transition metal compound onto the cermet base material and then heating the cermet base material on which the processing solution is applied.

[11] The extrusion method as recited in any one of the aforementioned Items 1 to 6, wherein the oxidation resistant film is constituted by spinel-type complex oxide.

[12] The extrusion method as recited in the aforementioned Item 11, wherein the oxidation resistant film is formed by applying a processing solution containing magnesium compound or cobalt compound onto the cermet base material and then heating the cermet base material on which the processing solution is applied.

[13] The extrusion method as recited in any one of the aforementioned Items 1 to 12, wherein a thickness of the oxidation resistant film is 0.5 μm or less.

[14] The extrusion method as recited in any one of the aforementioned Items 1 to 13, wherein the complex oxide has an oxygen ion close-packed crystal structure.

[15] The extrusion method as recited in any one of the aforementioned Items 1 to 14, wherein

the die main body includes a female die having a die hole;

the extrusion hole of a circular shape is formed between a mandrel arranged corresponding to the die hole and an inner peripheral surface of the die hole; and

a tubular extruded product is manufactured by passing forming material through the extrusion hole.

[16] The extrusion method as recited in any one of the aforementioned Items 1 to 15, wherein

the die hole is formed into a flattened shape; and

a portion of the mandrel corresponding to the die hole is formed into a comb-like configuration having a plurality of passage forming protrusions to thereby enable production of a flattened heat exchanging tube as the extruded product having a plurality of passages extending in an extrusion direction and arranged in a width direction of the extruded product.

[17] The extrusion method as recited in any one of the aforementioned Items 15 to 16, wherein aluminum or aluminum alloy is used as the extrusion material.

[18] A method of producing an extrusion die for use in the extrusion method as recited in any one of the aforementioned Items 1 to 17, comprising:

in forming the surface-coated cermet material,

a step of applying a processing solution containing metal salt which reacts with titanium compound on a surface of the cermet base material to create complex oxide onto a surface of the cermet base material constituted by a sintered body including at least one or more titanium compounds selected from the group consisting of titanium carbide, titanium nitride, and titanium carbonitride as a main component of a hard phase; and

a step of forming an oxidation resistant film by applying the processing solution and then heating the cermet base material on which the processing solution is applied after the step of applying the processing solution.

[19] A method of producing an extrusion die for use in the extrusion method as recited in any one of the aforementioned Items 1 to 17, comprising:

in forming the surface-coated cermet material,

a process of oxidizing the cermet base material of a sintered body including at least one or more titanium compounds selected from the group consisting of titanium carbide, titanium nitride, and titanium carbonitride as a main component;

a process of applying a processing solution containing metal salt which reacts with titanium compound on a surface of the cermet base material which the oxidation treatment was performed to produce the complex oxide; and

a process of forming the oxidation resistant film by heating the cermet base material on which the processing solution is applied after the process of applying processing solution.

### Effects of the Invention

According to the extrusion method of the invention [1], the die main body of the extrusion die is constituted by a surface-coated cermet material including a cermet base material as a main component constituted by a sintered body including at least one or more titanium compounds selected from the group consisting of titanium carbide, titanium nitride, and titanium carbonitride, and an oxidation resistant film provided at a section on the cermet base material corresponding to at least an inner peripheral surface of the extrusion hole and constituted by complex oxide containing titanium. Therefore, the oxidation resistance performance can be enhanced while maintaining the excellent performance of the titanium series sintered body. Furthermore, the surface-coated cermet material employed in the present invention can be easily produced by simply forming the oxidation resistant film on the cermet base material.

In the present invention, the extrusion die is preheated to a predetermined temperature, so the extrusion can be conducted smoothly. In other words, if the preheating temperature is too low, the extrusion pressure rises and temperature control becomes difficult, so there is a risk that smooth extrusion becomes difficult. On the other hand, if the preheating temperature is too high, created titanium oxide causes problems and the temperature control becomes difficult, so there is a risk that smooth extrusion becomes difficult.

According to the extrusion method of the invention [2], extrusion can be performed even more smoothly. If the preheating time is too short, the extrusion die will not be sufficiently preheated, and if the preheating time is too long, the extrusion die will be preheated excessively, so there is a risk that extrusion cannot be performed smoothly, in the same manner as mentioned above.

According to the extrusion method of the invention [3], the oxidation resistant film is exfoliated at the time of extrusion, which enables to maintain the excellent smoothness of the die main body.

According to the extrusion method of the invention [4], the excellent performance of the sintered titanium carbonitride can be obtained.

According to the extrusion method of the invention [5], the extrusion die can be manufactured more easily.

According to the extrusion method of the invention [6] to [12], oxidation resistance can be improved more assuredly.

According to the extrusion method of the invention [13], the oxidation resistant film can be exfoliated effectively.

According to the extrusion method of the invention [14], the oxidation resistant film has an oxygen ion close-packed crystal structure, which is a stable structure in which oxygen ion is hard to move, and therefore an oxidation resistant film (passive film) having excellent oxidation resistance can be formed.

According to the extrusion method of the invention [15], a tubular extruded product can be manufactured.

According to the extrusion method of the invention [16], a flattened heat exchanging tube as an extruded product can be manufactured.

According to the extrusion method of the invention [17], an extruded product of aluminum or aluminum alloy can be manufactured.

According to the method of producing an extrusion die of the invention [18] and [19], an extrusion die suitable for the aforementioned extrusion method can be assuredly manufactured.

### BRIEF EXPLANATION OF THE DRAWINGS

FIG. 1 is a cross-sectional view schematically showing a surface-coated cermet material used for an embodiment of the present invention.

FIG. 2 is a block diagram showing an example of a production process of the surface-coated cermet material used in the embodiment.

FIG. 3 is a block diagram showing another example of a production process of the surface-coated cermet material used in the embodiment of the present invention.

FIG. 4 is a cross-sectional view schematically showing a periphery of an extrusion die portion of an extruder used in the first embodiment of the present invention.

FIG. 5 is a graph showing changes of thermogravimetry of a sample of the present invention and a sample of a comparative example.

FIG. 6 is a perspective view showing an extrusion die used in a second embodiment of the present invention.

FIG. 7 is a cut-out perspective view of the extrusion die of the second embodiment.

FIG. 8 is an exploded perspective view of the extrusion die of the second embodiment.

FIG. 9 is a side cross-sectional view of the extrusion die of the second embodiment.

FIG. 10 is a cut-out perspective view of the main portion of the extruder to which the extrusion die of the second embodiment is applied.

FIG. 11 is a side cross-sectional view showing a periphery of a die of the extruder in the second embodiment.

FIG. 12 is a perspective view of a heat exchanging tube manufactured by the extruder of the second embodiment.

FIG. 13 is a front cross-sectional view of the heat exchanging tube of the second embodiment.

### EMBODIMENTS FOR CARRYING OUT THE INVENTION

### First Embodiment

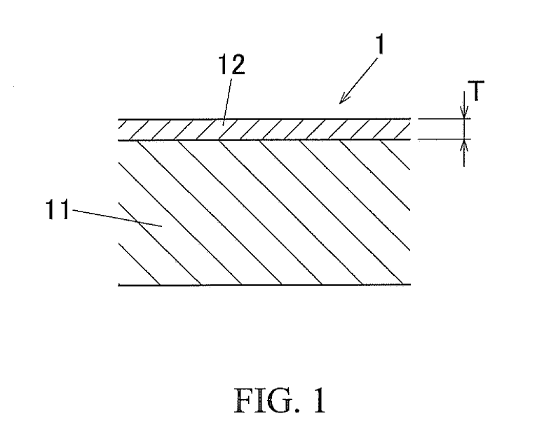

FIG. 1 is a cross-sectional view schematically showing a titanium series surface-coated cermet material 1 used in an embodiment of the present invention. As shown in this figure, this surface-coated cermet material 1 is provided with a cermet base material 11 and an oxidation resistant film 12 formed on the cermet base material 11.

The cermet base material 11 used in this embodiment is constituted by a sintered body of titanium carbonitride (TiCN). This TiCN series sintered body (TiCN series cermet) is constituted by a complex material including a hard phase including titanium carbonitride as a main component (a component whose content rate in the hard phase is 50 mass % or more) and a bonded phase including iron metal, such as, e.g., nickel (Ni) or cobalt (Co) as a main component (a component whose content rate in the bonded phase is 50 mass % or more).

In the present invention, the main component of the hard phase in the cermet base material 11 is not limited to titanium carbonitride, and can be at least one or more titanium compounds among titanium carbide, titanium nitride, and titanium cardonitride. For example, as the main component of the hard phase of the cermet base material 11, multicomponent system titanium compound, such as, e.g., TiCN—WC—TaC, TiC—WC—TaC, can be used.

Furthermore, in the present invention, the cermet base material is not always limited to a material constituted only by cermet. For example, the cermet base material can be constituted such that a cermet layer is formed on a surface of a material other than cermet, such as, e.g., dies steel or ceramics. Further, the method of forming a cermet layer on a surface of a material other than cermet, such as, e.g., dies steel or ceramics, is not specifically limited, and can preferably be, for example, a thermal spraying method or a PVD method.

The oxidation resistant film 12 is constituted by complex oxide containing titanium. It is preferable that the complex oxide containing titanium has an oxygen ion close-packed crystal structure. In cases where the complex oxide has an oxygen ion close-packed crystal structure, it has a stable structure in which oxygen ion is hard to move, which enables formation of an oxidation resistant film (passive film) excellent in oxidation resistance.

As the complex oxide, for example, perovskite (CaTiO₃)-type complex oxide, ilmenite (FeTiO₃)-type complex oxide, and spinel (MgAl₂O₄)-type complex oxide can be exemplified as preferable examples.

Among them, perovskite-type complex oxide and ilmenite-type complex oxide are extremely high in symmetry and stability in a crystal structure, which can more assuredly prevent movements of oxygen ion. This in turn can form an oxidation resistant film further enhanced in oxidation resistance.

As such perovskite-type complex oxide, oxide having a chemical composition of, e.g., CaTiO₃, SrTiO₃, or BaTiO₃, can be exemplified.

This perovskite-type complex oxide has, in a structure in which oxygen ions are face-centered cubic type close-packed, a structure in which a positive ion having a large ion radius, such as, Ca²⁺, Sr²⁺, or Ba²⁺, is substituted by an oxygen ion at a position of 12-coordinate, and a Ti⁴⁺ ion having a small ion radius is entered into the gap between the oxygen ion and the positive ion. In other words, it has a structure in which a small Ti⁴⁺ ion is entered into the gap between the close-packed large divalent positive ion and oxygen ion. This crystal structure is very stable, and as mentioned before, and has a structure in which oxygen ions are hard to move.

The oxidation resistant film 12 of perovskite-type complex oxide is formed by reacting alkaline-earth metal, such as, e.g., Ca, Sr, and Ba, with titanium oxide, such as, e.g., titanium oxide (TiO₂) formed on a surface of the cermet base material.

As the ilmenite-type complex oxide, oxide having a chemical composition of, e.g., FeTiO₃, NiTiO₃, CoTiO₃, MnTiO₃, MgTiO₃, or ZnTiO₃, can be exemplified.

This ilmenite-type complex oxide has the same crystal structure as that of corundum, and has, in an oxygen ion hexagonal close-packed structure, a structure in which cations are arranged at (six-coordinate) positions of oxygen ion gaps. In other words, it has a structure in which Fe²⁺, Ni²⁺, CO²⁺, Mn²⁺, Mg²⁺, Zn²⁺ ions having a small ion radius and Ti⁴⁺ ions are arranged in gaps of the close-packed oxygen ions. This crystal structure is also extremely stable, and, as explained above, has a structure in which oxygen ions are hard to move.

The oxidation resistant film 12 of ilmenite-type complex oxide is formed by reacting iron group divalent ion transition metal, such as, e.g., Fe, Ni, Co, Mn, Mg, or Zn, with titanium oxide formed on a surface of the cermet base material.

As the spinel-type complex oxide, oxide having a chemical composition of, e.g., MgTi₂O₄, Mg₂TiO₄, CoTi₂O₄, or Co₂TiO₄, can be exemplified.

This spinel-type complex oxide has a structure in which oxygen ions are closely packed into a face-oriented cubic shape. Spinel-type complex oxide including Ti is a crystal different in electric charge of Ti ion and slightly less in stability. However, Ti³⁺ ion is not actually observed, and although it is complex oxide of the same element, it is considered that this spinel-type complex oxide has a Mg₂TiO₄ spinel-type structure having tetrad Ti rather than triad MgTi₂O₄, or a structure in which Mg is arranged in the so-called A-site and Mg and Ti⁴⁺ are arranged in the B site.

On the other hand, in the present invention, titanium oxide of, e.g., anatase-type, rutile-type, Brookite-type formed on the cermet base material 11 will not be used as an oxidation resistant film 12. In other words, in these titanium oxides, oxygen ions are not closely-packed, and therefore the structure is brittle due to the non-compact structure. For this reason, in an aerobic environment of a high temperature of, e.g., 450° C. or above, a titanium oxide layer grows thick as time passes, and numerous cracks and/or holes are formed in the layer, making it difficult to obtain sufficient oxidation resistance.

Although rutile-type titanium oxide is relatively high in symmetry property among titanium oxides, it has a TiO₆ regular octahedron crystal structure with a distorted center and lacks stability. Therefore, the structure includes many gaps, which causes easy movements of oxygen ions, and therefore it is hard to prevent oxidation.

In the present invention, it is preferable that the thickness T of the oxidation resistant film 12 to be formed on the cermet base material 11 is adjusted to 0.5 μm or less, preferably 0.4 μm or less, and more preferably 0.1 μm or less. In other words, if the film thickness T is too large, as it will be explained later, the exfoliated surface of the oxidation resistant film 12 exfoliated from the extrusion die constituted by the surface-coated cermet material 1 according to the present invention might become rough. On the other hand, if the film thickness T is too thin, it might be difficult to obtain sufficient oxidation prevention effect.

Next, a process for forming the aforementioned oxidation resistant film 12 on the cermet base material 11 will be explained.

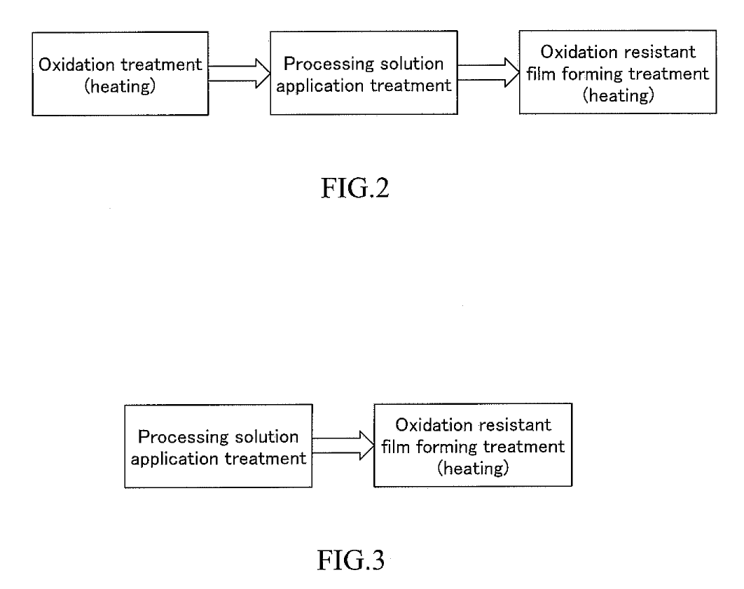

As shown in FIG. 2, initially, the cermet base material 11 is heated to perform oxidation treatment, and then a processing solution containing a predetermined metal salt is applied on the surface of the cermet base material 11 (processing solution application treatment). Thereafter, the cermet base material 11 is dried and then heated to have the metal salt in the processing solution react with the titanium oxide (oxide titanium) on the surface of the cermet base material to form complex oxide as an oxidation resistant film 12.

The metal salt which reacts with titanium oxide to form perovskite-type complex oxide is earth alkaline metal, such as, e.g., Ca, Sr and Ba, and the earth alkaline metal compound is contained in the processing solution. As the earth alkaline metal compound, for example, calcium acetate (such as calcium acetate 1 hydrate) can be exemplified.

The metal salt which forms ilmenite-type complex oxide is iron group divalent ion transition metal, such as, e.g., Fe, Ni, Co, Mn, Mg, and Zn, and the transition metal compound is contained in the processing solution. As a compound of the transition metal, for example, nickel acetate (nickel acetate (II), 4 hydrate) can be exemplified.

The metal salt which forms spinel-type complex oxide is salt of Mg or Co, and these metal compounds are contained in the processing solution. As the metal compound, for example, cobalt acetate (cobalt acetate (II), 4 hydrate) can be exemplified.

On the other hand, for the processing solution containing metal salt, aqueous or non-aqueous solvent is used depending on various additives to be added.

The film forming processing solution has a problem of “wettability” with respect to the surface of the cermet base material 11. If the “wettability” is poor, at the time of applying the processing solution onto the surface of the cermet base material, the processing solution is repelled by the surface of the cermet base material, which may make it difficult to form a desired oxidation resistant film 12 due to the insufficient application amount. Therefore, when the “wettability” is poor, the problem must be solved. In order to solve the problem, it can be preferable to employ a method in which an extremely thin oxide layer is formed on the surface of the base material by oxidizing the surface of the cermet base material 11 with oxygenated water or by oxidizing the surface of the cermet base material 11 by heating it in air. Further, the “wettability” can be improved by adding appropriate additives such as surfactant to the processing solution.

At the time of applying a processing solution onto the cermet base material 11, there arises a problem of “flowing down” of the processing solution depending on the viscosity of the processing solution. If the “flowing down” occurs, it becomes difficult to form a desired oxidation resistant film 12 because of insufficient processing solution. Since there always exists a protrusion especially in a three-dimensional shape, the “flowing down” easily occurs at the protrusion. For this reason, in the case of a processing solution using an aqueous solution, in order to solve the problem of “flowing down,” it is recommended to perform steps subsequent to drying treatment and heating treatment in a state in which occurrence of “flowing down” is assuredly prevented by adding aqueous paste (thickening agent) to the processing solution to give proper viscosity.

Depending on the type and/or density of the paste, the coated film after drying out the moisture may sometimes be exfoliated due to, e.g., contraction. This contraction-exfoliation problem can be solved by adding aqueous polyalcohol having a relatively high boiling point as a plasticizer. By adding it, the film can maintain elasticity even after drying out the moisture.

If the solubility of the metal salt in the processing solution is low, precipitation of the metal salt may sometimes occur. This solubility problem can be solved by adding organic acid, such as, e.g., formic acid, acetic acid, and citric acid to the processing solution.

Also, if it is necessary to lower the temperature of formation of complex oxides (for example, if it is necessary to lower to 500° C. or below), sodium salt (for example, sodium hydrogen carbonate) which produces complex oxides at a low temperature can be added as reaction auxiliary agent.

As mentioned above, an aqueous processing solution contains, for example, paste, surface acting agent, plasticizer, organic acid and reaction auxiliary agent in addition to metal salt and solvent, and is constituted by, e.g., slurry or paste having viscosity.

As a method for applying the processing solution onto the surface of the cermet base material 11, for example, a method of applying the processing solution with a brush, a method of spraying the processing solution with a spray, and a method of immerging the cermet base material 11 into the processing solution can be employed.

As described above, the oxidation resistant film 12 is formed by heating the cermet base material 11 after drying the processing solution applied on the cermet base material 11. The heating condition at the time of the film formation is, when sodium is not added, preferably set to 1 to 60 minutes at 380 to 700° C., more preferably 2 to 20 minutes at 570 to 620° C. In other words, if the heating temperature is too high, there is a risk that the progress of oxidation is faster than the formation of the oxidation resistant film 12, and if the heating temperature is too low or the heating time is too short, the formation of the oxidation resistant film 12 becomes insufficient or the oxidation resistant effect cannot be sufficiently obtained because the film thickness is too thin.

In the aforementioned example, oxidation treatment by heating is conducted prior to application of the processing solution to the cermet base material 11. Although it is preferable to facilitate the oxidation of titanium by heating before applying the processing solution, the heating oxidation treatment is not always necessary, and can be omitted. In other words, as shown in FIG. 3, it can be configured such that the processing solution is applied to the cermet base material 11 (processing solution application treatment) without performing heating oxidation treatment and then dried, and the oxidation resistant film formation treatment by heating is performed. In this way, even if oxidation treatment is not performed beforehand, a titanium oxide film is formed on the surface of the cermet base material 11 to some extent at the time of the oxidation resistant film formation, so the desired oxidation resistant film 12 can be formed by the reaction of titanium oxide and processing solution.

As it is obvious, even in the case of forming an oxidation resistant film 12 of any of perovskite-type complex oxide, ilmenite-type complex oxide and spinel-type complex oxide, the oxidation treatment before applying the processing solution can be omitted.

In this way, an oxidation resistant film 12 is formed on the surface of the titanium carbonitride series cermet base material 11, and the TiCN-type surface-coated cermet member 1 according to the present invention is produced. In the surface-coated cermet member 1, the component of the cermet base material 11 is the same as the component of the TiCN-type sintered body, and the property of the base material 11 will not change, and therefore the excellent performance of the TiCN-type sintered body can be assuredly obtained.

Furthermore, the surface-coated cermet member 1 according to the present invention can be easily manufactured by simply applying the processing solution onto the cermet base material 11 and heating it.

In particular, since the oxidation resistant film 12 is formed by reacting the metal salt in the processing solution with the titanium oxide film to be formed on the cermet base material 11, the oxidation resistant film 12 can be assuredly formed without being influenced by the type, etc., of the element contained in the cermet base material, resulting in easy formation of the oxidation resistant film 12, which in turn can more easily produce the surface-coated cermet member 1.

As will be apparent from the following embodiments, the surface-coated cermet member 1 according to the present invention can enhance the oxidation resistance, especially the oxidation resistance under high temperature environment.

In the first embodiment, the aforementioned surface-coated cermet member 1 is employed as an extrusion die. In the present invention, the entirety of the extrusion die can be constituted by the surface-coated cermet member 1, but in this embodiment, only a part (main portion) of the extrusion die is constituted by the surface-coated cermet member 1.

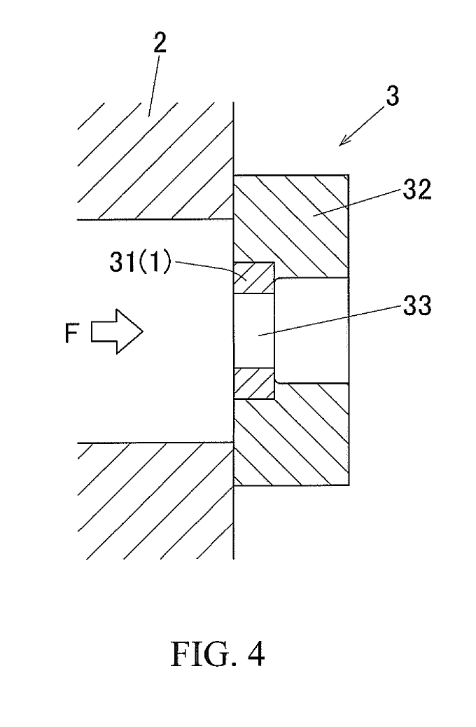

Specifically, the extrusion die 3 of the extruder shown in FIG. 4 is provided with a die main body 31 such as a bearing portion, and a die holder 32 supporting the die main body 31. The die main body 31 of the extrusion die 3 is constituted by the surface-coated cermet base material 1 and the die holder 32 is constituted by steel material, etc. In manufacturing the extrusion die 3 of this structure, for example, the cermet base material 11 as a die main body 31 is thermally inserted into the heated die holder 32, and then an oxidation resistant film 12 is formed on the cermet base material 11 as mentioned above so that the die main body 31 is constituted by the surface-coated cermet member 1.

The oxidation resistant film 12 can be formed on the entire peripheral surface of the die main body 31, or it can be formed only on the inner peripheral surface of the extrusion hole (bearing hole 33). In other words, the oxidation resistant film 12 can be formed on at least a part of the inner peripheral surface of at least the extrusion hole 33.

In the present invention, the die main body 31 denotes a member which forms the inner peripheral surface portion of the extrusion hole.

If the temperature at the time of forming the oxidation resistant film 12 exceeds the tempering temperature of the steel material, the hardness of the die holder 32 decreases. Therefore, the film forming temperature should be set to the tempering temperature of the steel material or below thereof. In the case of an SKD 61 hot work die steel material, complex oxide is preferably formed at 520° C. or below. This condition can be met by adjusting the temperature to around 500° C. and the heating time is set to around 30 minutes at the time of forming the film, which allows formation of the oxidation resistant film 12 having a film thickness of 0.2 μm. The heating temperature at the time of forming the film is relatively low as compared with the temperature for forming a general oxidation film, and the adhesiveness of the oxidation resistant film 12 with respect to the cermet base material 11 is not so high. As will be mentioned later, however, in this embodiment, it is required to remove (exfoliate) the oxidation resistant film 12 promptly from the cermet base material 11 after the initiation of the extrusion processing, and therefore even if the adhesiveness of the oxidation resistant film 12 is not high, no inconvenience occurs, and it meets the condition in which the oxidation resistant film 12 is promptly removed at a desired time.

Next, an extrusion process using the extrusion die 3 having the aforementioned structure will be explained. Before actually performing the extrusion, the extrusion die 3 is preheated in a preheating furnace. At the time of preheating, the extrusion die 3 is exposed to the oxygen atmosphere under a high temperature, but because the die main body 31 of the extrusion die 3 is constituted by the surface-coated cermet member 1, oxidation of the cermet base material 11 is prevented by the oxidation resistant film 12, which prevents formation of titanium oxide. Therefore, emboritllement of the surface due to formation of titanium oxide can be prevented, effectively preventing falling off at the time of extrusion performed later, which can improve the corrosion resistance and durability. The preheating conditions are the same as those of a second embodiment which will be explained later.

After completion of the preliminary heating, the extrusion die 3 is set to the container 2 of the extruder and extrusion processing is initiated. At the time of this extrusion processing, the extrusion material (metal material F) in the container 2 is moved toward the extrusion die 3 in a pressurized state and passes through the extrusion hole 33 of the extrusion die 3 to thereby form an extruded product. On the other hand, when the extrusion processing is initiated, the oxidation resistant film 12 of the surface-coated cermet member 1 constituting the die main body 31 is scraped away by the extrusion member F flowing in a pressurized state. Thus, the oxidation resistant film 12 is quickly removed (exfoliated). With this, the die main body 31 is constituted by a bared cermet base material 11 having no film. As a result, the die main body 31 can fully exert the excellent performance (excellent performance such as hard to react with aluminum or its alloy) of the TiCN series sintered body (cermet base material). For this reason, for example, dimensional stability, strength, and hardness of the die main body 31 can be sufficiently obtained, resulting in a stable and smooth extrusion with high dimensional accuracy. This makes it possible to obtain an extruded product with high quality in terms of surface state and dimensional accuracy and also makes it possible to prevent early deterioration, breakage, and dropping, which in turn can assuredly improve the deterioration resistance, corrosion resistance, and durability. Further, by using the TiCN sintered body as a die, weight saving of the die can be attained.

In this first embodiment, it is preferable to constitute such that the oxidation resistant film 12 of the die main body (surface-coated cermet material 1) is exfoliated by 90% or more when an extruded product is extruded by 10 m from the initiation of the extrusion. That is, if the exfoliated amount of the oxidation resistant film after the extrusion is too small, there is a risk that it becomes difficult to sufficiently exert the excellent performance of the TiCN series sintered body.

The oxidation resistant film exfoliated from the die main body (surface-coated cermet material) will be included in the extrusion material.

### Example 1

In the same manner as in the first embodiment, a cermet base material constituted by titanium carbonitride series sintered body was prepared. As a processing solution for forming an oxidation resistant film, a compound in which 9.3 mass parts of acetic acid Ni (II) 4-hydrate, 4.7 mass parts of polyvinylpyrrolidone (paste), 1.9 mass parts of alkyl glucoside (surfactant), 5.6 mass parts of glycerine (polyalcohol), 4.9 mass parts of citric acid, 6.5 mass parts of sodium hydrogen carbonate (sodium), and 67.1 mass parts of water were mixed was also prepared.

After applying the processing solution to a surface of the cermet base material, it was dried and heated up to 500° C. in a circulating hot air oven in the atmosphere (in air), maintained at 500° C. for 30 minutes to form an oxidation resistant film constituted by ilmenite-type complex oxide (NiTiO₃ layer) on the cermet base material to thereby obtain a surface-coated cermet material. In this case, the oxidation resistant film formed on the surface showed blue interference color.

The surface-coated cermet member obtained in this way was tested for changes in thermogravimetry under the following conditions, based on the TGA (thermogravimetric analysis, thermogravimetric measurement).

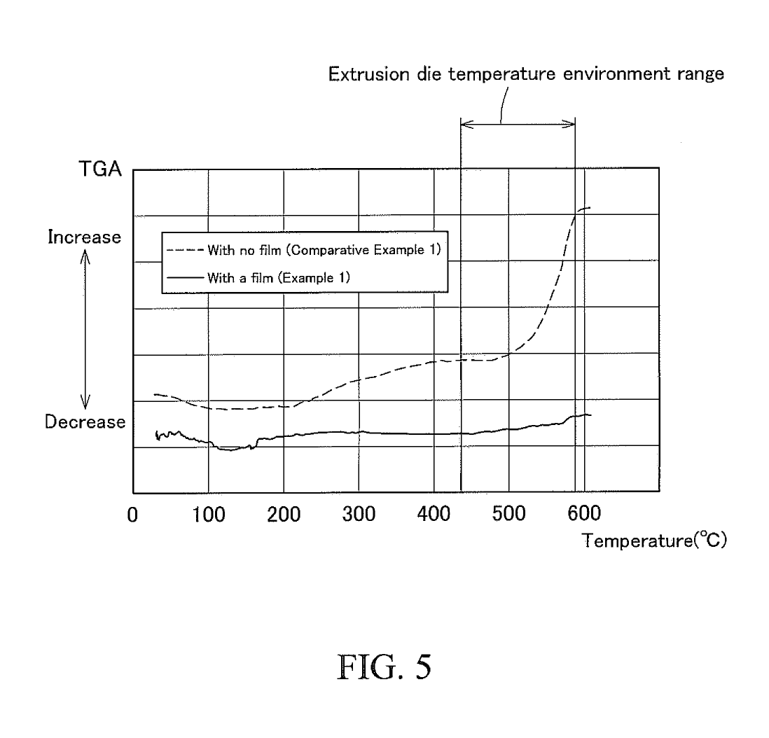

At this time, a testing apparatus with a product name of “DTG60H” manufactured by Shimadzu Corporation was used as a testing apparatus. Furthermore, a test sample of the surface-coated cermet member in this Example 1 was 3 mm×4 mm×0.15 mm. This sample was disposed in a cell of alumina and set in the testing equipment. The change in thermogravimetry was measured in the atmosphere (in air) while setting the temperature raising rate to 1° C./min. The measured results are shown in FIG. 5.

### Comparative Example 1

A cermet base material made of the same titanium carbonitride sintered body as in the aforementioned Example 1 in which no oxidation resistant film was formed was used as a sample of a Comparative Example and subjected to a similar test. The test results are also shown in FIG. 5.

### [Evaluation of Oxidation Resistance]

As will be apparent from FIG. 5, in Example 1 having an oxidation resistant film, there was almost no change in thermogravimetry (weight increase) even if the heating temperature rose, which revealed that oxidation barely progressed.

On the other hand, in Comparative Example having no oxidation resistant film, as the heating temperature rose, the weight increased, which revealed that oxidation progressed. Especially in Comparative Example, the weight increased rapidly within the extrusion die temperature environment range, which revealed that oxidation progressed rapidly within this temperature environment range.

As explained above, in the first embodiment, even if the material was exposed to oxygen atmosphere under high temperatures, oxidation of the cermet base material can be assuredly prevented. Therefore, it is considered to effectively prevent inconveniences due to oxidation, such as, e.g., damages and/or exfoliation due to surface deterioration.

### Example 2

In the same manner as in Example 1, a cermet base material constituted by titanium carbonitride series sintered body was prepared.

A mixture in which 9.8 mass parts of calcium acetate monohydrate, 3.9 mass parts of polyvinylpyrrolidone (paste), 1.4 mass parts of alkyl glucoside (surfactant), 4.4 mass parts of glycerine (polyalcohol), 24.4 mass parts of acetic acid, 4.9 mass parts of sodium acetate (sodium salt), and 51.2 mass parts of water were mixed was prepared as a processing liquid. This processing liquid was applied to the surface of the cermet base material and raised in temperature in air by a circulating hot air oven (electric furnace) to 500° C. and then held at 500° C. for 30 minutes. Thus, an oxidation resistant film constituted by complex oxide (CaTiO₃ layer) was formed on the cermet base material to thereby obtain a surface-coated cermet material. In this case, the oxidation resistant film presented glossy silver gray color.

The test sample made of the surface-coated cermet material according to this Example 2 was subjected to the same test as mentioned above. As a result, the same evaluation was obtained. In other words, also in Example 2, it was confirmed that there was no sudden weight increase up to the temperature range of 600° C. and the material was excellent in oxidation resistance.

### Example 3

As the processing solution, a compound in which 14.7 mass parts of acetic acid Co (II) 4-hydrate, 6.2 mass parts of polyvinylpyrrolidone (paste), 1.8 mass parts of alkyl glucoside (surfactant), 2.1 mass parts of glycerine (polyalcohol), and 75.2 mass parts of water were mixed was prepared. The processing solution was applied to a surface of the cermet base material, dried and heated up to 600° C. in air by a circulating hot air oven (electric furnace), maintained at 600° C. for 30 minutes to form a spinel-type complex oxide (Co₂TiO₄ layer) on the cermet base material to thereby obtain a surface-coated cermet material of Example 3. In this case, it was observed that an oxidation resistant film showed a bluish glossy color though not clear.

The test sample constituted by the surface-coated cermet material of Example 3 was subjected to the same test as mentioned above. As a result, the same evaluation was obtained. In other words, also in Example 3, it was confirmed that there was no sudden weight increase up to the temperature range of 600° C. and the material was excellent in oxidation resistance.

In order to evaluate the oxidation resistance of the surface-coated cermet material of Examples 1 to 3 and Comparative Example 1 obtained as mentioned above in actual use, the die main body 31 of the extrusion die 3 was constituted by each surface-coated cermet material 1, and an aluminum alloy round bar was extruded using this extrusion die 3.

The production of the extrusion die 3 was performed as follows. That is, a cermet base material 11 as a die main body 31 was thermally fitted to a heated die holder 32 of steel and then the oxidation resistant film was formed on the cermet base material 11 to thereby constitute the die main body 31 by the surface-coated cermet material 1 to produce an extrusion die 3. The heating temperature at the time of forming the oxidation resistant film was set to 500° C. and the heating time was set to 30 minutes. Thus, an oxidation resistant film 12 having a film thickness of 0.2 μm was formed.

Next, in performing the extrusion using the extrusion die 3, the extrusion die 3 was preheated at 450° C. for 300 minutes in a preheating furnace. Thereafter, the extrusion die 3 was set to a container of an extruder and an aluminum alloy round bar was extruded at a billet temperature of 450° C. The wear volume of the surface-coated cermet material 1 as a die main body 31 at the time when the extrusion length has reached 50,000 m was evaluated. The evaluation results of the wear volume are shown in Table 1.

TABLE 1

| | Cermet base | Oxidation | |
|---|---|---|---|
| | material | resistant film | Wear volume |
| Example 1 | TiCN series | Ilmenite-tye | 4 |
| | sintered body | complex oxide | |
| | | (NiTiO₃) | |
| Example 2 | TiCN series | Perovskite-type | 4 |
| | sintered body | complex oxide | |
| | | (CaTiO₃) | |
| Example 3 | TiCN series | Spinel-type | 5 |
| | sintered body | complex oxide | |
| | | (Co₂TiO₄) | |
| Comparative | TiCN series | Nil | Larger than 30 μm |
| Example 1 | sintered body | | |
| Comparative | WC-Co super | Nil | 7 |
| Example 2 | hard | | |

As will be apparent from Table 1, in the extruded product produced using the extrusion die constituted by the surface-coated cermet material of Examples 1 to 3 of the present invention, the wear volume of the surface-coated cermet material was little and sufficient durability for a die was obtained.

On the other hand, in the extruded product produced using the extrusion die constituted by the cermet material of Comparative Example 1 with no oxidation resistant film (surface coating), the 50,000 m extrusion evaluation could not be performed. That is, at the time when the extrusion length has reached 10,000 m, the wear volume of the cermet material has reached 30 μm, and it was confirmed that the surface of the die after 10,000 m extrusion was dropped due to oxidation. In this Comparative Example 1, the wear was extremely quick as compared to conventional WC-Co super hard material of Comparative Example 2.

### Second Embodiment

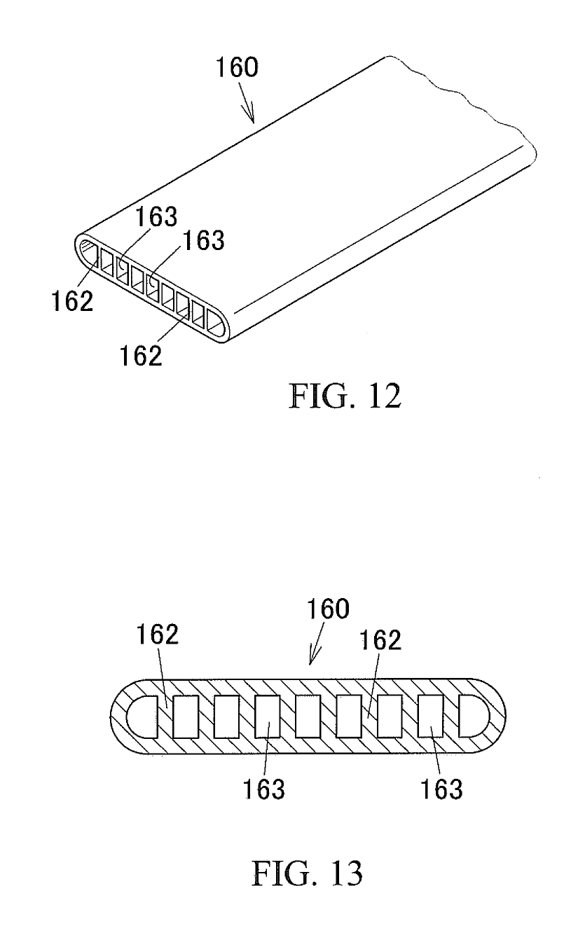

FIGS. 12 and 13 show a heat exchanging tube 160 as an extruded tube to be produced by the second embodiment of the present invention.

As shown in these figures, this heat exchanging tube 160 is a flat hollow shaped aluminum or aluminum alloy tube for use in a heat exchanger, such as, e.g., a condenser for an automobile. The hollow portion of this tube 160 extends in a tube length direction and divided by a plurality of partition walls 162 arranged in parallel into a plurality of cooling medium passages 163. These cooling medium passages 163 are extended in a direction of the tube length and arranged in parallel along the tube width direction.

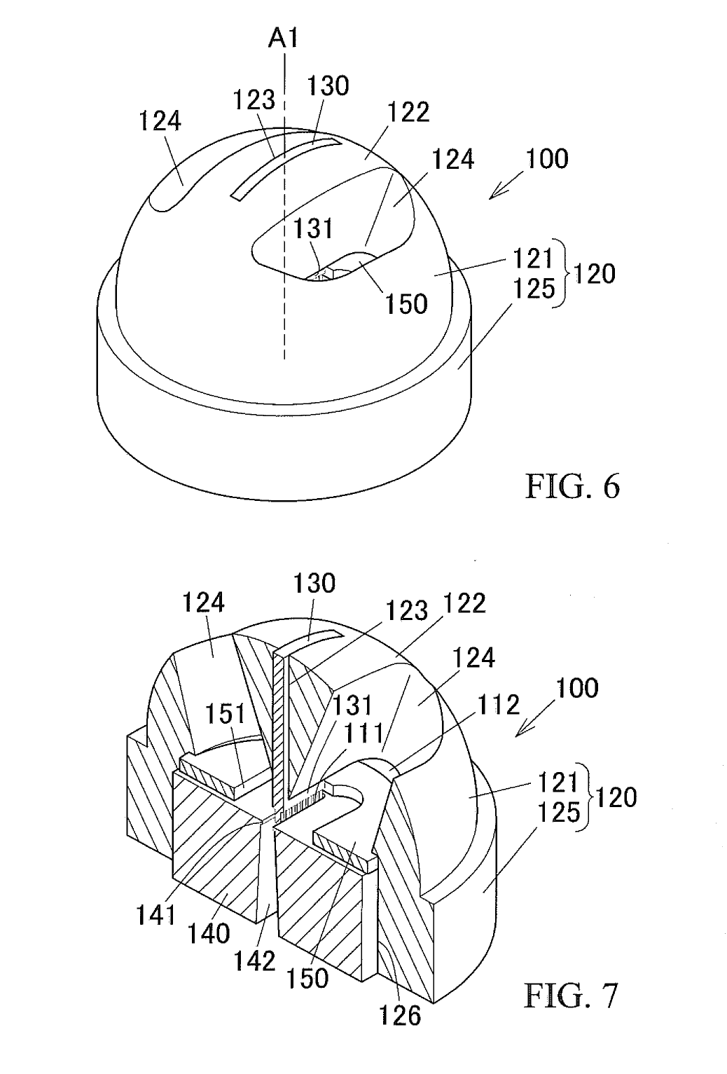

As shown in FIGS. 6 to 9, an extrusion die 100 for producing the aforementioned heat exchanging tube 160 includes a die case 120, a male die 130, and a female die 140, and a fluid control plate 150 as basic structural elements.

The die case 120 has a hollow structure and has a dome portion 121 arranged at an upstream side (rear side) with respect to an extrusion direction of the metal billet as an extrusion material (extrusion member) and a base portion 125 arranged at the downstream side (front side).

The dome portion 121 is formed such that the surface (rear face) facing against the extrusion direction is formed as a pressure receiving surface 122. This pressure receiving surface 122 is formed into a hemispherical convex spherical shape protruded in the direction facing against the extrusion direction (i.e., protruded in the rear direction).

The dome portion 121 is provided, at the peripheral central portion, with a male die retaining hole 123 communicating with the inner hollow portion (weld chamber 112) along the center axis A1. This male die retaining hole 123 is formed into a flat rectangular shape corresponding to the cross-sectional shape of the male die 130.

At both sides of the peripheral wall of the dome portion 121, a pair of portholes 124 and 124 are formed at both sides of the center axis. Each porthole 124 is formed into an elongated shape extending along the circumference direction, and the pair of portholes are arranged so as to be opposed with each other at an equal interval in the circumferential direction. Each porthole 124 extends so as to approach the center axis A1 of the dome portion 121 as it approaches toward the downstream side (forward side).

In this embodiment, it is constituted such that the center axis of the die case 120 and the center axis of the dome portion 121 coincide with each other.

The base portion 125 is integrally formed with the dome portion 121, and the outer peripheral surface of the base portion is formed so as to protrude outward of the other end side outer periphery of the dome portion 121.

At the inner side of the base portion 125, a female die retaining hole 126 communicating with the inner weld chamber 112 and having a cylindrical shape corresponding to the cross-sectional shape of the female die 140 is formed. The center axis of this female die retaining hole 126 is constituted so as to coincide with the center axis A1 of the die case 120.

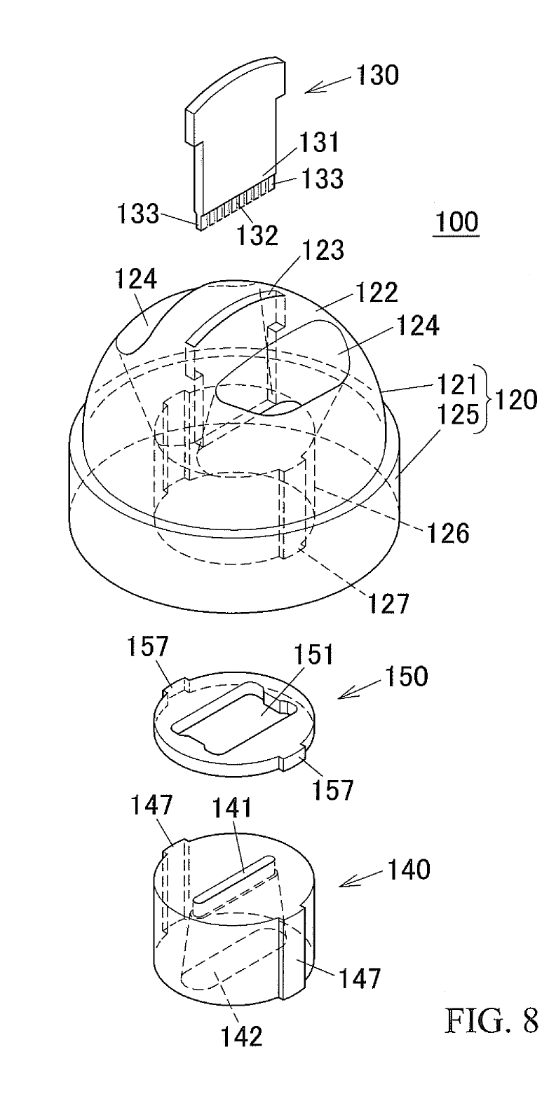

Further, as shown in FIG. 8, at both side portions of the inner peripheral surface of the female die retaining hole 126, key grooves 127 and 127 parallel to the center axis A1 of the die case 120 are formed.

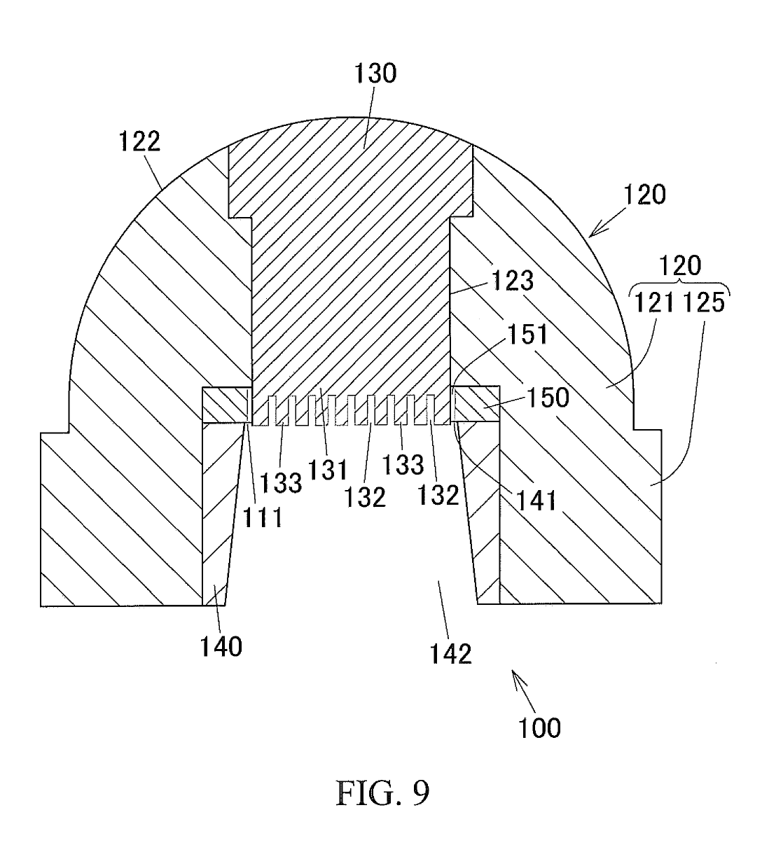

In the male die 130, the front principal portion constitutes a mandrel 131. As shown in FIGS. 8 and 9, the front end portion of the mandrel 131 is configured to form a hollow portion of the heat exchanging tube 160 and has a plurality of passage forming protruded portions 133 each corresponding to each passage 163 of the heat exchanging tube 160. The plurality of passage forming protruded portions 133 are arranged in the width direction of the mandrel 131 at certain intervals. The gap formed between the passage forming protruded portions 133 constitutes a partition wall forming groove 132 for forming a partition wall 162 of the heat exchanging tube 160.

This male die 130 is inserted into the male die retaining hole 123 of the die case 120 from the pressure receiving surface 122 and fixed therein. In this fixed state, the mandrel 131 of the male die 130 is arranged so as to protrude by a certain amount from the male die retaining hole 123 in the die case 120.

The basal end face (rear end face) of the male die 130 is formed to constitute a part of the spherical surface forming the pressure receiving face 122 of the die case 120, and it is constituted such that the basal face (rear end face) of the male die 130 and the pressure receiving face 122 form a desired smooth protruded spherical surface.

As shown in FIGS. 7 to 9, the female die 140 is formed into a cylindrical shape and has, at its both side portions of the outer peripheral portion, key protrusions 147 and 147 parallel to the center axis corresponding to the key grooves 127 and 127 of the female die retaining hole 126 of the die case 120 are formed.

The female die 140 is provided with a die hole (bearing hole 141) opened at the rear end face side and corresponding to the mandrel 131 of the male die 130 and a relief hole 142 communicating with the die hole 141 and opened to the front end face side.

The die hole 141 include an inwardly protruded portion along the inner peripheral edge portion so as to define the outer peripheral portion of the heat exchanging tube 160. Further, the relief hole 142 is formed into a divergent tapered shape in which the thickness (height) gradually increases toward the front end side (downstream side) and opens toward the downstream side.

The outer circumferential shape of the flow control plate 150 is formed into a circular shape corresponding to the cross-sectional shape of the female die retaining hole 126 of the die case 120. Furthermore, at the center of the flow control plate 150, a central penetrating hole 151 is formed corresponding to the mandrel 131 of the male die 130 and the die hole 141 of the female die 140.

As shown in FIG. 8, on both side portions of the outer circumferential edge portions of the flow control plate 150, key protrusions 157 and 157 are formed corresponding to the key grooves 127 and 127 of the female die retaining hole 126 of the die case 120.

The female die 140 is inserted and fixed in the female die retaining hole 126 of the die case 120 via the flow control plate 150. At this time, the key protrusions 147 and 147 of the female die 140 and the key protrusions 157 and 157 of the flow control plate 150 are engaged with the key grooves 127 and 127 of the female die retaining hole 126, so that the position in the direction centering the center axis is determined. The mandrel 131 of the male die 130 and the die hole 141 of the female die 140 are disposed inside and corresponding to the central penetrating hole 151 of the flow control plate 150. Consequently, the mandrel 131 of the male die 130 is disposed inside the die hole 141 of the female die 140, and a flat circular extrusion hole 111 is formed between the mandrel 131 and the die hole 141. Furthermore, in the extrusion hole 111, a plurality of partition wall forming grooves 132 of the mandrel 131 are disposed in parallel in the width direction, and has a shape corresponding to the cross-sectional shape of the heat exchanging tube 60.

In the second embodiment, the female die 140 among the components of the extrusion die 100 is constituted by the surface-coated cermet member 1 used in the first embodiment.

In the second embodiment, an oxidation resistant film 12 can be formed on all circumferential surfaces of the female die 140 as the cermet base material 11, or an oxidation resistant film 12 can be formed only on the inner circumferential surface of the die hole 141 of the female die 140.

In addition, in the second embodiment, a die main body is constituted by the female die 140.

Also, in the present invention, among the components of the extrusion die 100, any components other than the female die 140, such as, e.g., the male die 130, can be constituted by the surface-coated cermet member 1.

Furthermore, in the present invention, the inner circumferential surface of the extrusion hole includes not only the inner circumferential surface of the die hole of the female die but also the outer circumferential surface of the mandrel of the male die.

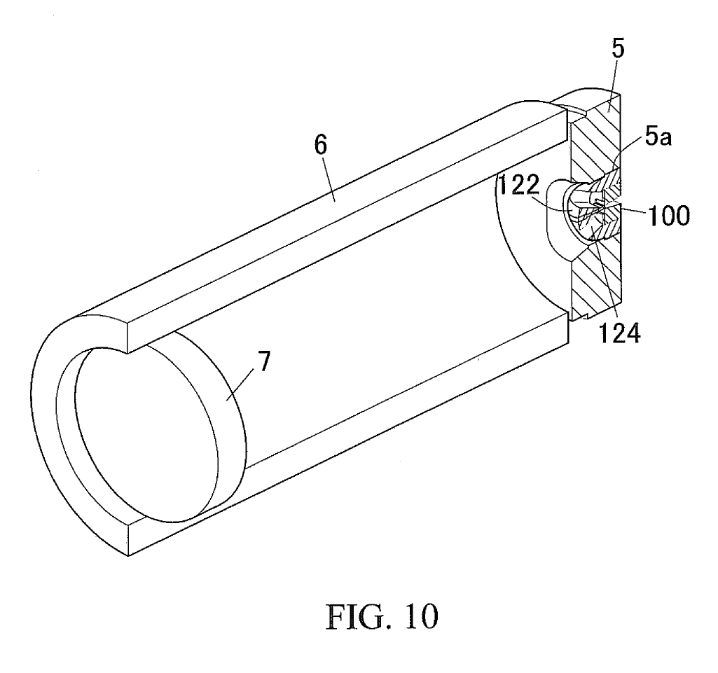

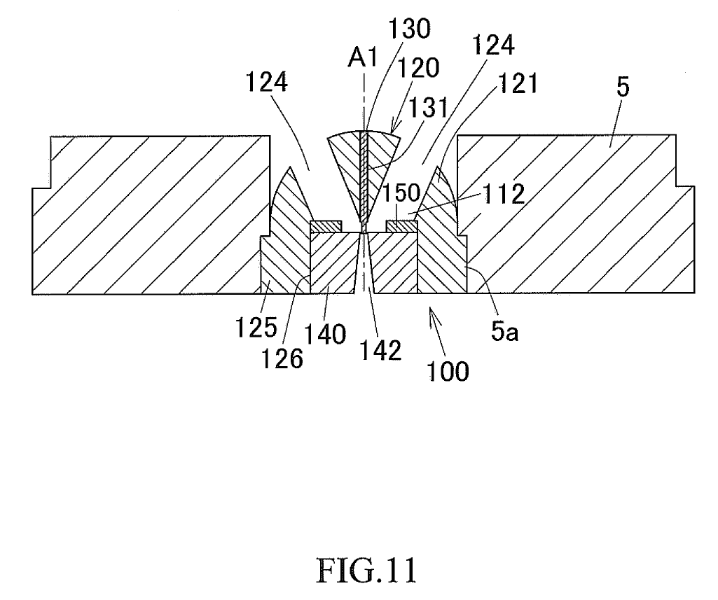

The extrusion die 100 of the second embodiment constituted as mentioned above is set to the extruder as shown in FIGS. 10 and 11. In detail, the extrusion die 100 is set into the container 6 in a state in which the extrusion die 100 is attached to the die mounting hole 5a formed in the center of the plate 5. The extrusion die 100 is fixed in a direction perpendicular to the extrusion direction by the plate 5 and also fixed in the extrusion direction by a backer that is not illustrated.

Next, a metal billet (extrusion material), such as, e.g., an aluminum billet, inserted into the container 6 is pushed in the right direction (extrusion direction) in FIG. 10 via a dummy block 7. Consequently, the metal billet is plastically deformed by being pushed against the pressure receiving surface 122 of the die case 120 of the extrusion die 100. In this way, the extrusion material flows through the pair of portholes 124 and 124 while being plastically deformed and is then inserted into the welding chamber 112 of the die case 120 and further extruded forwardly through the extrusion hole 111. Thus, the aforementioned heat exchanging tube 160 having a cross-sectional shape corresponding to the opening shape of the extrusion hole 111 is formed.

When the extrusion is initiated in this way, the oxidation resistant film 12 of the surface-coated cermet member 1 constituting the female die 140 is shaved off by the extrusion material (metal billet) flowing in a pressurized state, and the oxidation resistant film 12 is quickly eliminated (exfoliated). With this, the die hole inner circumferential surface (bearing hole inner circumferential surface) of the female die 140 is constituted by the cermet base material 11 exposed without film, and the female die 140 starts to exhibit its excellent performance (excellent performance that it does not easily react with aluminum or aluminum alloy) inherent in a TiCN-type sintered body (cermet base material). Therefore, for example, the dimensional stability, the strength, and the hardness of the female die 140 can be sufficiently maintained. This results in accurate and smooth extrusion in a stable state, which in turn can produce a heat exchanging tube high in surface condition and dimensional accuracy and also can assuredly prevent premature deterioration, damage, and exfoliation. As a result, the deterioration resistance, friction resistance, and durability can be assuredly improved. Also, by using a TiCN sintered body as the die, weight saving of the die can be realized.

In addition, in the second embodiment, the extrusion die 100, in the same manner as in the first embodiment, is pre-heated before extrusion (before setting it in the container). When pre-heating, the extrusion die 100 is fixed by the plate 5 and the backer which is not shown in the drawing, and when pre-heating the die, the set of die is pre-heated together.

For the conditions for the pre-heating, it is preferable that the heating temperature is set to 420 to 520° C., more preferably 450 to 500° C., and the heating time is set to 28 hours or less, preferably 4 hours or longer, more preferably 24 hours or less.

If the pre-heating temperature is too low, the extrusion pressure during the extrusion processing becomes high and restrictions of the temperature range increase, resulting in difficult temperature control, which may make it difficult to perform smooth extrusion. On the other hand, if the pre-heating temperature is too high, inconveniences due to the formation of titanium oxide occur and the temperature control becomes difficult, which may make it difficult to perform smooth extrusion.

If the pre-heating time is too short, the extrusion die cannot be sufficiently pre-heated. While, if the pre-heating time is too long, the extrusion die is pre-heated excessively, which may make it difficult to perform smooth extrusion in the same manner as mentioned above.

### Example 11

TABLE 2

| | | | Die | Die | |
|---|---|---|---|---|---|
| | Components of female die | | pre-heating | pre-heating | |
| | | Oxidation resistant film | temperature | time | Extrusion |
| | Base material | on the surface | (° C.) | (hour) | length (m) |
| Example 11 | TiCN-series | Ilmenite-type complex | 420 | 8 | 30,000 |
| | cermet | oxide (NiTiO₃) | | | |
| Example 12 | Same as above | Same as above | 450 | 4 | 30,000 |
| Example 13 | Same as above | Same as above | 450 | 8 | 30,000 |
| Example 14 | Same as above | Same as above | 450 | 24 | 30,000 |
| Example 15 | Same as above | Same as above | 450 | 28 | 12,000 |
| Example 16 | Same as above | Same as above | 500 | 24 | 30,000 |
| Example 17 | Same as above | Same as above | 520 | 24 | 18,000 |
| Comp. Example 11 | Same as above | None (Anatase-type) | 450 | 4 | 2,000 |
| Comp. Example 12 | Same as above | None (No oxidation film) | 420 | 4 | 25,000 |
| Comp. Example 13 | Same as above | None (Anatase-type) | 420 | 6 | 4,000 |
| Comp. Example 14 | WC-Co super hard | None | 450 | 6 | 15,000 |
| | material | | | | |

As shown in Table 2, a similar extrusion die 100 as the aforementioned second embodiment was used. Here, as the female die 140 of the extrusion die 100, a female die was used in which the base material of the die 140 was constituted by a titanium carbonitride series cermet and a surface-coated film layer (oxidation resistant film) constituted by ilmenite-type complex oxide (NiTiO₃ layer) was formed on the surface of the base material in the same manner as in the aforementioned Example 1.

Among the components of the extrusion die 100, the components other than the female die 140 were steel materials.

The extrusion die 100 was pre-heated for 8 hours at 420° C. and subjected to extrusion in the same manner as in the second embodiment.

Next, the extrusion length (an extruded mount per die) up to where the outer surface roughness of the heat exchanging tube 160 as an extruded product (extrusion product) exceeded 5 μm was measured.

### Example 12

As shown in Table 2, extrusion was performed in the same manner as in Example 11 and similar measurements were performed except that the pre-heating temperature of the die 100 was set to 450° C. and the pre-heating time was set to 4 hours.

### Example 13

As shown in Table 2, extrusion was performed in the same manner as in Example 12 and similar measurements were performed except that the pre-heating time was set to 8 hours.

### Example 14

As shown in Table 2, extrusion was performed in the same manner as in Example 12 and similar measurements were performed except that the pre-heating time was set to 24 hours.

### Example 15

As shown in Table 2, extrusion was performed in the same manner as in Example 12 and similar measurements were performed except that the pre-heating time was set to 28 hours.

### Example 16

As shown in Table 2, extrusion was performed in the same manner as in Example 12 and similar measurements were performed except that the pre-heating temperature of the die 100 was set to 500° C. and the pre-heating time was set to 24 hours.

### Example 17

As shown in Table 2, extrusion was performed in the same manner as in Example 12 and similar measurements were performed except that the pre-heating temperature of the die 100 was set to 520° C. and the pre-heating time was set to 24 hours.

### Comparative Example 11

As shown in Table 2, as the female die 140 of the extrusion die 100, a female die was used in which the base material of the die 140 was constituted by a titanium carbonitride series cermet and a surface-coated film layer constituted by anatase-type oxide was formed on the inner circumferential surface of the die hole. In addition, as detailed in the first embodiment, the anatase-type titanium oxide was different from the oxidation resistant film of the present invention.

Using the extrusion die 100, in the same manner as in Example 12, extrusion was performed and similar measurements were performed.

### Comparative Example 12

As shown in Table 2, using the female die 140 with no oxidation resistant film on the inner circumferential surface of the die hole, extrusion was performed in the same manner as in the aforementioned Comparative Example 11 and similar measurements were performed except that the pre-heating temperature was set to 420° C.

### Comparative Example 13

As shown in Table 2, extrusion was performed and similar measurements were performed in the same manner as in Comparative Example 11 except that the pre-heating temperature was set to 420° C. and the pre-heating time was set to 6 hours

### Comparative Example 14

As shown in Table 2, extrusion was performed in the same manner as in Example 12 and similar measurements were performed except that WC-Co ultrahard material was used for the female die 140 and pre-heating time was set to 6 hours.

### Evaluation

As shown in Comparative Examples 11 and 13, in the extrusion die 100 in which the female die 140 was a titanium carbonitride series cermet base material with no oxidation resistant film, the extrusion length was very short when the pre-heating temperature was set to 450° C. (Comparative Example 1) or when the pre-heating time was set to 6 hours (Comparative Example 3). Furthermore, the inner circumferential surface of the die hole (bearing surface) was extremely rough, and the life span of durability caused by early friction was a big problem. Also, as shown in Comparative Example 2, when pre-heating was conducted at 420° C. for 4 hours, the extrusion length was comparatively long, and excellent results were obtained. Based on these results, in a female die in which the female die 140 was constituted by a titanium carbonitride series cermet base material with no oxidation resistant film (Comparative Examples 11 to 13), the pre-heating temperature of 420° C. and the pre-heating time of 4 hours were the upper limits, and if pre-heating is conducted excessively, it is considered that inconveniences due to creation of titanium oxide will occur.

Additionally, in Comparative Example 12, although the extrusion length was comparative long, with these pre-heating conditions, since the heating condition (temperature×time) was low for a die for extrusion, it is considered that the extrusion pressure becomes high, which makes it difficult to perform smooth extrusion. Furthermore, because the pre-heating condition is extremely limited, it is considered that temperature control is difficult and it may be unreasonable for use in actual production.

Also, for Comparative Example 14, as compared to Comparative Examples 11 and 13, satisfactory evaluation could be obtained even when the heating temperature at the time of pre-heating was high, and the restrictions of the pre-heating conditions were slightly relaxed.

On the other hand, as shown in Examples 11 to 14, in the cases where the female die 140 was constituted by a titanium carbonitride series cermet base material on which an oxidation resistant film was formed, even if the heating temperature at the time of pre-heating was slightly high, sufficient extrusion length could be obtained regardless of the length of heating time.

As shown in Examples 15 to 17, the extrusion length could be secured to some extent even if the pre-heating temperature was set extremely high or when the heating time was set extremely long. Consequently, in Examples 11 to 17 according to the present invention, restrictions on the pre-heating conditions could be kept extremely few, and especially in Examples 11 to 14, the extrusion length could be longer, and longer durability and efficient productivity could be maintained.

Specifically, in a female die in which ilmenite-type complex oxide (NiTiO₃ layer) was formed on the surface of the titanium series carbonitride cermet base material, that is, a female die according to the present invention, for the pre-heating condition, the heating temperature can be set to 420 to 520° C., and more preferably 450 to 500° C., and the heating time can be set to 28 hours or less, preferably 4 hours or longer, more preferably 24 hours or less.

In addition, the aforementioned Examples 11 to 17 used a female die in which an ilmenite-type complex oxide (NiTiO₃ layer) oxidation resistant film was formed on the surface of the titanium carbonitride series cermet base material. However, when extrusion was performed in the same manner as in Examples 11 to 17 and similar measurements were performed for a female die in which a perovskite-type complex oxide (CaTiO₃ layer) oxidation resistant film layer was formed on the titanium carbonitride series cermet base material like Example 2 and for a female die in which a spinel-type complex oxide (Co₂TiO₄ layer) oxidation resistant film layer was formed on the titanium carbonitride series cermet base material like Example 3, similar results to the aforementioned Examples 11 to 17 were obtained. Therefore, the oxidation resistant film is not limited to ilmenite-type complex oxide (NiTiO₃ layer), and similar conditions can be set for pre-heating condition for perovskite-type complex oxide (CaTiO₃ layer) and spinel-type complex oxide (Co₂TiO₄ layer).

This application claims priority to Japanese Patent Application No. 2010-15021 filed on Jan. 27, 2010, and the entire disclosure of which is incorporated herein by reference in its entirety.

It should be understood that the terms and expressions used herein are used for explanation and have no intention to be used to construe in a limited manner, do not eliminate any equivalents of features shown and mentioned herein, and allow various modifications falling within the claimed scope of the present invention.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example;” and “NB” which means “note well.”

### INDUSTRIAL APPLICABILITY

The extrusion method of the present invention can be used for extrusion technology using an extrusion die constituted by a titanium series sintered body.

### DESCRIPTION OF THE REFERENCE NUMERALS

1: surface-coated cermet material
11: cermet base material
12: oxidation resistant film
3, 100: extrusion die
42: die main body
33: bearing hole (extrusion hole)
111: extrusion hole
131: mandrel
133: passage forming protrusion
140: female die (die main body)
141: die hole (bearing hole)
F: extrusion material
T: film thickness

1. An extrusion method of extruding an extrusion material through an extrusion hole of a die main body of an extrusion die,
wherein the die main body is constituted by a surface-coated cermet material including a cermet base material constituted by a sintered body including as a main component of a hard phase at least one or more titanium compounds selected from the group consisting of titanium carbide, titanium nitride, and titanium carbonitride, and an oxidation resistant film provided at a section on the cermet base material corresponding to at least an inner peripheral surface of the extrusion hole and constituted by complex oxide containing titanium, and
wherein the extrusion die is preheated to a temperature of 420 to 520° C. before initiating the extrusion.

2. The extrusion method as recited in claim 1, wherein a preheating time of the extrusion die is set to 24 hours or less.

3. The extrusion method as recited in claim 1, wherein the extrusion is performed such that, after initiating the extrusion, the oxidation resistant film on the inner peripheral surface of the extrusion hole is exfoliated to be removed by the extrusion material passing through the shaped hole.

4. The extrusion method as recited in claim 1, wherein the titanium compound is constituted by titanium carbonitride.

5. The extrusion method as recited in claim 1, wherein the oxidation resistant film is formed by applying a processing solution containing metal salt which reacts with the titanium compound on a surface of the cermet base material to produce the complex oxide onto the cermet base material and then heating the cermet base material on which the processing solution is applied.

6. The extrusion method as recited in claim 5, wherein oxidation treatment is conducted for the cermet base material in advance before applying the processing solution.

7. The extrusion method as recited in claim 1, wherein the oxidation resistant film is constituted by perovskite-type complex oxide.

8. The extrusion method as recited in claim 7, wherein the oxidation resistant film is formed by applying a processing solution containing alkaline earth metal compound onto the cermet base material and then heating the cermet base material on which the processing solution is applied.

9. The extrusion method as recited in claim 1, wherein the oxidation resistant film is constituted by ilmenite-type complex oxide.

10. The extrusion method as recited in claim 9, wherein the oxidation resistant film is formed by applying a processing solution containing iron group divalent ion transition metal compound onto the cermet base material and then heating the cermet base material on which the processing solution is applied.

11. The extrusion method as recited in claim 1, wherein the oxidation resistant film is constituted by spinel-type complex oxide.

12. The extrusion method as recited in claim 11, wherein the oxidation resistant film is formed by applying processing solution containing magnesium compound or cobalt compound onto the cermet base material and then heating the cermet base material on which the processing solution is applied.

13. The extrusion method as recited in claim 1, wherein a thickness of the oxidation resistant film is 0.5 μm or less.

14. The extrusion method as recited in claim 1, wherein the complex oxide has an oxygen ion close-packed crystal structure.

15. The extrusion method as recited in claim 1, wherein
the die main body includes a female die having a die hole;
the extrusion hole of a circular shape is formed between a mandrel arranged corresponding to the die hole and an inner peripheral surface of the die hole; and
a tubular extruded product is manufactured by passing forming material through the extrusion hole.

16. The extrusion method as recited in claim 1, wherein
the die hole is formed into a flattened shape; and
a portion of the mandrel corresponding to the die hole is formed into a comb-like configuration having a plurality of passage forming protrusions to thereby enable production of a flattened heat exchanging tube as the extruded product having a plurality of passages extending in an extrusion direction and arranged in a width direction of the extruded product.

17. The extrusion method as recited in claim 15, wherein aluminum or aluminum alloy is used as the extrusion material.

18. A method of producing an extrusion die for use in the extrusion method as recited in claim 1, comprising:
in forming the surface-coated cermet material,
a process of applying a processing solution containing metal salt which reacts with titanium compound on a surface of the cermet base material to create complex oxide onto a surface of the cermet base material formed of a sintered body including at least one or more titanium compounds selected from the group consisting of titanium carbide, titanium nitride, and titanium carbonitride as a main component of a hard phase; and
a process of forming an oxidation resistant film by applying the processing solution and then heating the cermet base material on which the processing solution is applied.

19. A method of producing an extrusion die for use in the extrusion method as recited in claim 1, comprising:
in forming the surface-coated cermet material,
a process of oxidizing the cermet base material of a sintered body including at least one or more titanium compounds selected from the group consisting of titanium carbide, titanium nitride, and titanium carbonitride as a main component;
a process of applying a processing solution containing metal salt which reacts with titanium compound on a surface of the cermet base material which the oxidation treatment was performed to produce the complex oxide; and
a process of forming the oxidation resistant film by heating the cermet base material on which the processing solution is applied after the process of applying processing solution.
